(19) United States
(12) Patent Application Publication
(10) Pub. No.: US 2005/0053909 A1
(43) Pub. Date: Mar. 10, 2005

(54) Learn-and-play programming method for motorized toys and domestic appliances

(76) Inventor: Kwok Hung Chan, Hong Kong (HK)

Correspondence Address: Raymond Y. Chan, Suite 128, 108 N. Ynez Ave., Monterey Park, CA, 91754, US

(21) Appl. No.: 10/657,032

(22) Filed: Sep. 8, 2003

(51) Int. Cl. A63H 30/00; G09B 25/00

(52) U.S. Cl. 434/365; 446/175

(57) ABSTRACT

A learn-and-play programming method, for controlling a mechanical movement of an output shaft of a motorized toy and a domestic appliance, includes the steps of: learning the mechanical movement of the output shaft by inputting a movement data into the operation system corresponding to the mechanical movement of the output shaft and storing the movement data of the output shaft in a memorizing means; and reproducing the mechanical movement of the output shaft corresponding to the movement data in the memorizing means. Therefore, the operation system is executed through the learning program to repeatedly control the mechanical movement of the output shaft.

### BACKGROUND OF THE PRESENT INVENTION

1. Field of Invention

The present invention relates to motorized toys and domestic appliances, and more particularly to a learn-and-play programming method for motorized toys and domestic appliances, which can automatically memorize the mechanical movements of the motorized device so as to repeatedly reproduce the mechanical movements thereof through a learning program.

2. Description of Related Arts

Servomotor, which is considered as one of the common motor used in motorized assembly, is a motor device that have an angular feedback sensor mounted on its output shaft so that the rotational movement of the output shaft can be controlled to any specific angle using a close-loop-feedback servomotor control system. There are many angular feedback sensors in the world and the most common angular feedback sensor is a rotational variable resistor. The resistance value of the rotational variable resistor will be gradually increased from zero to a certain maximum valve when the output shaft rotates from zero degree to 360 degrees correspondingly. This means that each resistance value on the rotational variable resistor is representing a unique position of the output shaft of the servomotor.

According to a conventional servomotor control programming, each servomotor is controlled by assembly language programming that stored inside the control system. In order to program a servomotor to rotate a specific position, the conventional servomotor control programming can be manipulated by either inputting the position data using assembly language inside the program source code or using an advance program mode in some of the advance robot arm. The advance programming mode allows the programmer to control each servomotor on the device to any specific position by using control keys panel. The programmer can then control each servomotor by observation as feedback signal. The programmer can stop the servomotor when the servomotor joint reaches the correct position. Then, the current data of the position can be stored inside the program so that the servomotor will be played back the mechanical movement corresponding to the stored data through the execution of the program.

However, such program is complicated that only the programmer or a person who skilled in that art can operate the program. In other words, the control program is not user-friendly such that the user, such as a young child or a housewife, is unable to operate the motorized toys or domestic appliances through the control program. In addition, due to the relatively high cost of the program, motorized toys and domestic appliances are unreasonable to employ with the control program that the manufacturing cost of such motorized toys and domestic appliances will highly be increased.

### SUMMARY OF THE PRESENT INVENTION

A main object of the present invention is to provide a learn-and-play programming method for motorized toys and domestic appliances, which can automatically memorize the mechanical movements of the motorized device so as to repeatedly reproduce the mechanical movements thereof through a learning program.

Another object of the present invention is to provide a learn-and-play programming method, wherein the user is able to manipulate the control program through computer, manual operation, or servomotor assembly. In other words, the learn-and-play programming method of the present invention is user-friendly that an individual is able to operate the motorized device through the program.

Another object of the present invention is to provide a learn-and-play programming method, wherein the operation of the control system is easy and simply that by operating the control system at a learn mode to memorize the mechanical movement of the output shaft of the servomotor and then switching the control system at a play mode to reproduce the mechanical movement of the output shaft of the servomotor.

Another object of the present invention is to provide a learn-and-play programming method, wherein no expensive or complicated programming and mechanical structure is required to employ in the present invention in order to achieve the above mentioned objects. Therefore, the present invention successfully provides an economic and efficient solution for controlling the mechanical movement of the output shaft of the servomotor especially incorporating with the motorized toys and domestic appliances.

Accordingly, in order to accomplish the above objects, the present invention provides a learn-and-play control system for controlling a motorized toy or a domestic appliance which comprises an output shaft to provide a mechanical movement thereof, wherein the learn-and-play control system comprises:
means for memorizing the mechanical movement of the output shaft; and
an operation system which is communicatively connected with the memorizing means and is arranged to be operated between a learn mode and a play mode, wherein at the learn mode, the memorizing means is activated for memorizing the mechanical movement of the output shaft, and at the play mode, the operation system is activated for driving the output shaft to reproduce the mechanical movement thereof.

The present invention further provides a learn-and-play programming method for controlling a mechanical movement of an output shaft of a motorized toy or a domestic appliance, comprising the steps of:
(a) learning the mechanical movement of the output shaft by:
(a.1) inputting a movement data into an operation system corresponding to the mechanical movement of the output shaft; and
(a.2) storing the movement data of the output shaft in a memorizing means; and
(b) reproducing the mechanical movement of the output shaft corresponding to the movement data in the memorizing means.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a learn-and-play control system for a motorized toy and domestic appliance according to a preferred embodiment of the present invention.

FIG. 2 is an exploded perspective view of a servomotor of the learn-and-play control system for the motorized toy and domestic appliance according to the above preferred embodiment of the present invention.

FIG. 3 illustrates the motorized toy incorporating with the servomotors according to the above preferred embodiment of the present invention.

FIG. 4 is a block diagram illustrating the learn-and-play control system according to the above preferred embodiment of the present invention.

FIG. 5 is a flow chart illustrating the learn-and-play programming method according to the above preferred embodiment of the present invention.

### DETAILED DESCRIPTION OF THE PREFERRED EMBODIMENT

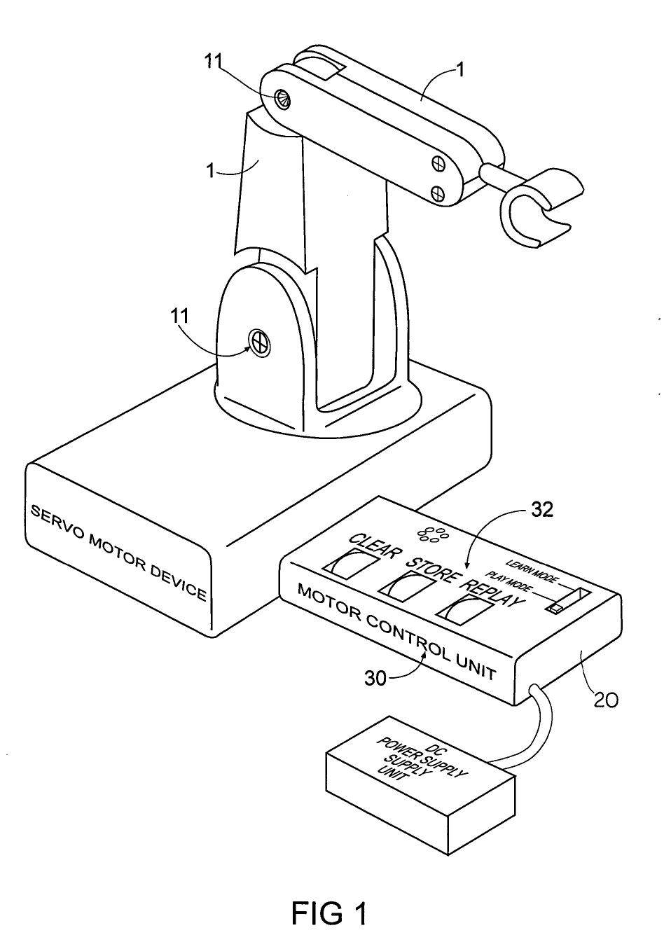

Referring to FIGS. 1 through 3 of the drawings, a learn-and-play control system for controlling a motorized toy or a domestic appliance according to a preferred embodiment is illustrated, wherein the motorized toy or a domestic appliance comprises a motor assembly 10, which is preferably a servomotor, having an output shaft 11 to provide a mechanical movement thereof.

The learn-and-play control system comprises means 20 for memorizing the mechanical movement of the output shaft 11, and an operation system 30 which is communicatively connected with the memorizing means 20 and is arranged to be operated between a learn mode and a play mode. In which, at the learn mode, the memorizing means 20 is activated for memorizing the mechanical movement of the output shaft 11, and at the play mode, the operation system 30 is activated for driving the output shaft 11 to reproduce the mechanical movement thereof.

The present invention further provides a learn-and-play programming method for controlling the mechanical movement of the output shaft 11 of a motorized toy or a domestic appliance, comprising the steps of:
(1) Learn the mechanical movement of the output shaft 11 by:
(1.1) inputting a movement data into the operation system 30 corresponding to the mechanical movement of the output shaft 11, and
(1.2) storing the movement data of the output shaft 11 in a memorizing means 20.
(2) Reproduce the mechanical movement of the output shaft 11 corresponding to the movement data in the memorizing means 20.

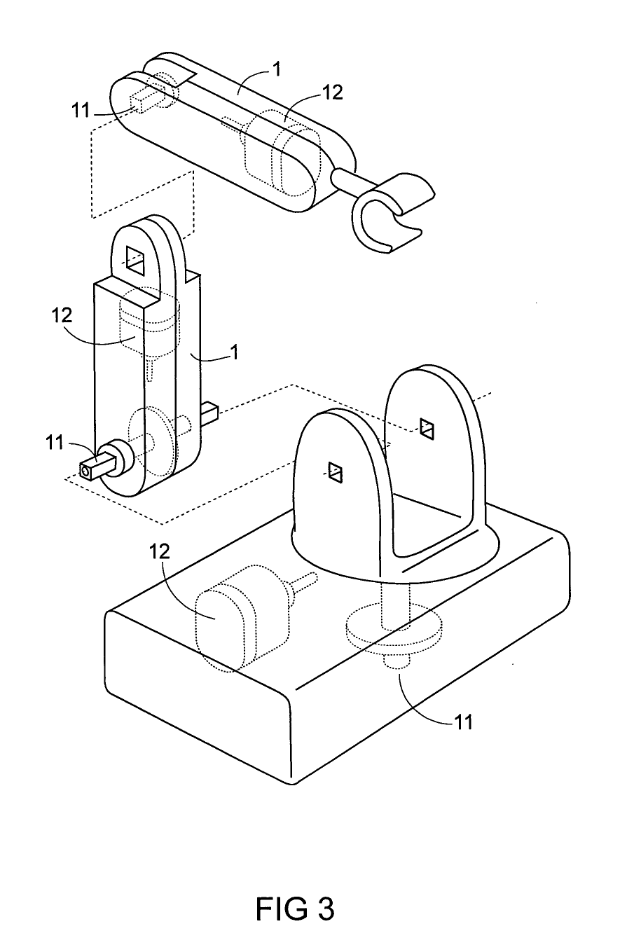

According to the preferred embodiment, the motorized device is embodied as a mechanical arm of the motorized toy which is constructed by a plurality of arm body 1 wherein the output shaft 11 is embodied as a joint to rotatably connect each two arm bodies 1 with each other, as shown in FIGS. 1 and 3. In other words, each of the arm bodies 1 is driven to rotate via the mechanical movement of the respect output shaft 11. Accordingly, the mechanical movement of the motorized toy can be an angular movement of the output shaft 11 or a linear movement thereof.

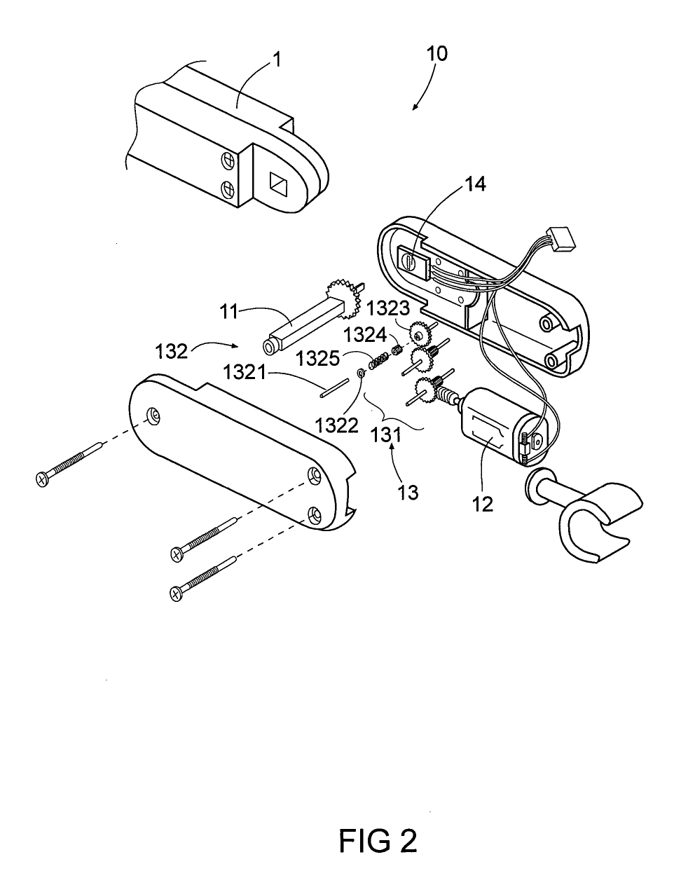

The motor assembly 10 is embodied as a DC motor assembly, wherein each of the arm bodies 1 is constructed as a motor assembly to receive the motor assembly 10 therein, as shown in FIG. 2.

The motor assembly 10 comprises a DC motor 12 electrically connected to a DC power supply, a clutch gear assembly 13 operatively connected the DC motor 12 with the output shaft 11 so as to drive the output shaft 11 to provide the mechanical movement when the DC motor 12 is operated, and a rotary sensor 14 mounted to the output shaft 11 to detect a position of the output shaft 11, i.e. the angular position of the output shaft 11. In other words, when a power signal is sent to the DC motor 12, the DC motor 12 drives the output shaft 11 to rotate through the clutch gear assembly 13 such that the rotary sensor 14 is adapted to measure the position of the output shaft 11.

The clutch gear assembly 13 comprises a gear unit 131 operatively connected to the DC motor 12 and a clutch unit 132 connected the gear unit 131 with the output shaft 11. The clutch unit 132 comprises a clutch shaft 1321, a metal stopper 1322 coaxially mounted on the clutch shaft 1321, a first clutch cog 1323 coaxially attached to an end of the clutch shaft 1321 to rotatably engage with the gear unit 131, a second clutch cog 1324 slidably mounted to the clutch shaft 1321 at a position between the metal stopper 1322 and the first clutch cog 1323, and a compression spring 1325 coaxially mounted on the clutch shaft 1311 for applying an urging force on the second clutch cog 1324 to rotatably engage with the first clutch cog 1323 so as to drive the output shaft 11 to rotate. Accordingly, the output shaft 11 is capable of being rotated without turning on the DC motor 12 by slidably slipping the second clutch cog 1324 with respect to the first clutch cog 1323.

The memorizing means 20, according to the preferred embodiment, is a storage media adapted for storing and memorizing the mechanical movement of the output shaft 11 via the rotary sensor 14. Accordingly, the mechanical movement of the output shaft 11 is converted into the movement data in order to store in the memorizing means 20. In addition, the memorizing means 20 can be activated to clear the movement data stored therein simply by erasing the movement data or overwriting the movement data by a new set of movement data.

The operation system 30 is arranged to operate the motorized device to actuate the mechanical movement of the output shaft 11. Accordingly, the operation system 30 comprises a program to be operated between the learn mode and the play mode. At the learn mode, the output shaft 11 is operated to perform the mechanical movement such that the mechanical movement of the output shaft 11 is stored in the memorizing means 20. The following steps show the operation of the present invention.

In step (1), the user is able to select the mechanical movement of the output shaft 11 wherein the mechanical movement of the output shaft 11 is converted into the readable movement data that is capable of being stored into the operation system 30 in steps (1.1) and (1.2).

In step (2), when the operation system is operated to the play mode, the movement data stored in the memorizing means 20 will be retrieved such that the movement data is sent back to the output shaft 11 to reproduce the mechanical movement thereof.

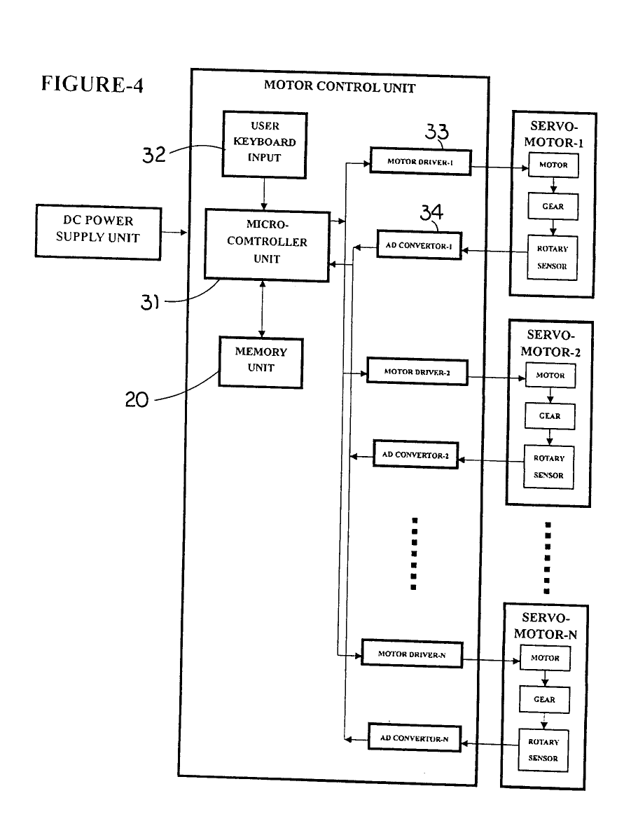

FIG. 4 illustrates a block diagram of the operation system 30. The operation system 30 comprises a micro control unit (MCU) 31, a keyboard input interface 32, a motor driver unit 33, and an analog to digital converter (A/D converter) 34.

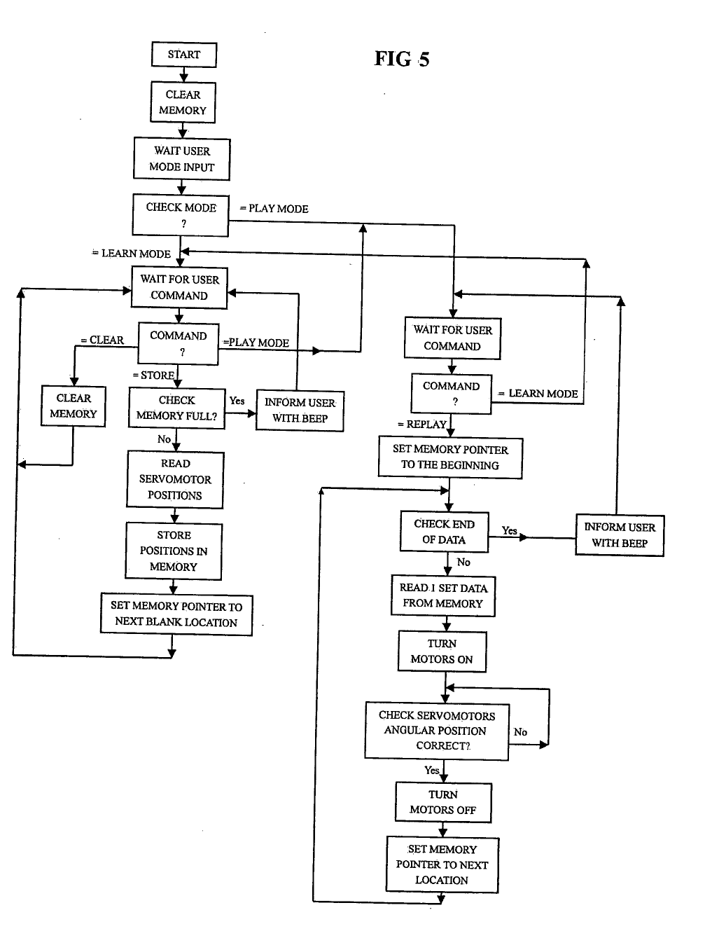

The micro control unit 31 is a controller which control the learn mode and play mode operation of the output shaft 11 wherein a control program is stored in the micro control unit 31 and the control program algorithm is shown in FIG. 5. Preferably, the memorizing means 20 is built-in with the operation system 30 to communicate with the micro control unit 31.

The keyboard input interface 32 is for mode selection to select the learn mode or play mode, and entering command. According to the preferred embodiment, there are three commands provided in the demonstration, which are ‘CLEAR’, ‘STORE’, and ‘PLAY’. The ‘CLEAR’ command is for clearing the movement data in the memorizing means 20. The ‘STORE’ command is for storing the position of the output shaft 11 in the memorizing means 20. The ‘PLAY’ command is for playback the mechanical movement of the output shaft 11.

The motor driver unit 33 is a high power driving unit that helps the micro control unit 31 to drive external high power and high current device such as the servomotor.

The analog to digital converter 34 is a signal device that is adapted to convert an analog signal of the rotary sensor 14 to digital format so that the micro control unit 31 can store the position of the output shaft in the memorizing means 20.

FIG. 5 is a flow chart to demonstrate the operation of the learn-and-play programming method of the present invention, which comprises the following steps.
(Step A) The program starts with power-up reset.
(Step B) The micro control unit 31 clears the movement data in the memorizing means 20 and sets data pointer to the beginning.
(Step C) The micro control unit 31 waits for user mode selection: learn mode or play mode.
(Step D) If the learn mode is selected:
   a. The micro control unit 31 waits for user command: ‘CLEAR’, ‘STORE’, or ‘PLAY’ mode.
   b. If ‘CLEAR’ command is selected, clear all movement data in the memorizing means 20 and sent data pointer to zero.
   c. If ‘STORE’ command is selected, then check whether the memory in the memorizing means 20 is full or not. If not, the memory means 20 will store the angular data therein and set data point to next blank memory location, which will be used for next set of movement data. Otherwise, a beep sound will be provided to inform the user that the memory is full. The current movement data cannot be stored.
   d. If ‘PLAY’ command is selected, the micro control unit 31 will jump to the play mode. Otherwise, the micro control unit 31 will loop back to step (D.a) to wait for user command.
(Step E) If play mode is selected:
   a. The micro control unit 31 waits for user command: Replay or Learn mode.
   b. If Replay command is selected, the program will read the position of each output shaft 11 from the memorizing means 20 set by set. Each set of movement data is representing a single step of the angular motion of each output shaft 11. The micro control system 31 will use the movement data to drive the output shaft 11 to that particular position in order to replay that step of angular motion that had been learned before.
   c. If learn mode is selected, the micro control unit 31 will jump to learn mode.
   d. Otherwise, the micro control unit will loop back to step (E.a) to wait for the user command.

According to the preferred embodiment, in step (1) of the learn-and-play programming method of the present invention, the user is able to input the movement data into the operation system 30, which is embodied as a learning program to guide the operation system 40 to understand the mechanical movement of the output shaft 11.

Accordingly, there are several ways to input the movement data into the operation system 30 in step (1.1). The following examples mainly illustrate the use of the learn-and-play control system of the present invention.

FIG. 1 illustrates a first method to operate the present invention. In order to input the movement data into the operation system for the mechanical arm of the motorized toy, the step (1.1) comprises the steps of:
(1.11) activating the operation system 30 through a computer system;
(1.12) switching the operation system 30 at the learn mode such that the computer system is capable of communicating with the motorized toy so as to measure the mechanical movement of the output shaft 11;
(1.13) manually inputting an initial position of the output shaft 11 through the computer system such that the computer system is adapted to convert the position of the output shaft 11 into the movement data thereof; and
(1.14) repeating the step (1.13) to input a secondary position of the output shaft 11 until a final position of the output shaft 11 is input into the operation system.

Therefore, by using the computer system, a sequence of the movement data of the output shaft 11 is stored in the memorizing means 20 in step (1.2). Then, the computer system is adapted to activate the operation system 30 so as to switch the operation system 30 from the learn mode to the play mode. The movement data of the output shaft 11 stored in the memorizing means 20 will then be recalled such that the output shaft 11 will be reproduced the mechanical movement correspondingly in step (2).

It is worth to mention that the learn-and-play programming process of the present invention is manipulated through the computer system such that the user, such as a young child, is able to preset the mechanical movement of the output shaft 11, such as 90 degrees of mechanical movement, through the computer system in step (1.13). Accordingly, the initial position and the final position of the output shaft 11 are embodied as an initial angular position and a final angular position respectively for the servomotor.

The user is able to input more than one mechanical movement of the output shaft 11 through the computer system in step (1.14) so that the output shaft 11 can reproduce the mechanical movements step by step. In other words, when the user inputs the initial position of the output shaft 11 to rotate 90 degrees in a clockwise direction and then the final position of the output shaft 11 to rotate 180 degrees in a counterclockwise direction. At the learn mode, the output shaft 11 will reproduce the rotation of 90 degrees in a clockwise direction and then 180 degrees in a counterclockwise direction respectively at the play mode.

It is worth to mention that the movement data must be input into the operation system 30 and stored in the memorizing means 30 before inputting another movement data of the output shaft. In addition, the angular data in the memorizing means 20 must be cleared in order to store new sets of the angular data from the output shaft in the memorizing means 20.

The second method to operate the learn-and-play control system is to build the mechanical arm of the motorized toy by using the predetermined mechanical movement of the output shaft 11. As it is mentioned above, the output shaft 11 is embodied as the joint to rotatably connect with each two arm bodies 1. Therefore, the user is able to construct the mechanical arm by using the desired output shaft 11 with the predetermined mechanical movement.

Accordingly, in step (1), the mechanical movement is pre-input into the output shaft 11 and the movement data is pre-stored in the memorizing means 20. For example, a first output shaft 11, having a predetermined mechanical movement of 90 degrees in clockwise direction, is arranged to connect the first arm body 1 with a second arm body 1, and a second output shaft 11, having a predetermined mechanical movement of 180 degrees in counterclockwise direction, is arranged to connect the second arm body 1 with a third arm body 1. Therefore, when the operation system 30 is switched to the play mode, the first and second output shafts 11 will reproduce the mechanical movements of rotating 90 degrees in clockwise direction and 180 degrees in counterclockwise direction respectively.

In other words, the user is able to build the mechanical arm by selectively connecting the arm bodies 1 with different output shafts 11 with different predetermined mechanical movements as like the user plays with building blocks to put the output shafts 11 and the arm bodies 1 together to form the mechanical arm.

The third method to operate the learn-and-play control system is to input the mechanical movement of the output shaft 11 step by step. Accordingly, the step (1′) comprises the steps of:
(1.1°) inputting the mechanical movement of the output shaft 11 by manually rotating the output shaft 11 from an initial position to a first position.
(1.2°) storing the mechanical movement of the output shaft;
(1.3°) repeatedly the steps (1.1°) and (1.2°) until the output shaft 11 is rotated to a final position.

Accordingly, the user is able to rotate the output shaft 11 by moving the respective arm body 1. For example, the user operates the learn-and-play control system by:
(1^{st}) pivotally moving the first arm body 1 to rotate the first output shaft 11 with 90 degrees in clockwise direction so as to store the first mechanical movement of the output shaft 11 in the memorizing means 20;
(2^{nd}) pivotally moving the second arm body 1 to rotate the second output shaft 11 with 180 degrees in counterclockwise direction so as to store the second mechanical movement of the output shaft 11 in the memorizing means 20; and
(3^{rd}) pivotally moving the first arm body 1 again to rotate the first output shaft 11 with 270 degrees in counterclockwise direction so as to store the third mechanical movement of the output shaft 11 in the memorizing means 20.

In this set of data, there are three sequences of mechanical movements of the output shafts 11 stored in the memorizing means 20, such as by simply pressing a store button on the operation system 30 to memorize the mechanical movement of the output shaft 11. Therefore, when the operation system 30 is switched to the play mode, the mechanical arm will be driven to reproduce the three sequences of mechanical movements of the output shafts 11 correspondingly.

Accordingly, the three mechanical movements can be input into the memorizing means 20 by pressing the store button after each step of mechanical movements so as to store the three mechanical movements as three sets of mechanical movements. Alternatively, the three mechanical movements can be input as a single sequence step by pressing the store button after continuously completing the three mechanical movements in sequence.

It is worth to mention that after the step (1.3°), the output shaft 11 is rotated back to the initial position before the output shaft 11 reproduces the corresponding mechanical movement thereof.

Another example illustrates the learn-and-play programming method of the present invention employing in the domestic appliances such a vacuum cleaner. The user, such as a housewife, is able to preset a path for moving the vacuum cleaner. For example, the user operates the learn-and-play control system by:
(1^{st}) moving the vacuum cleaner from a starting position to a first desired position, so as to store the first movement of the vacuum cleaner in the memorizing means 20;
(2^{nd}) moving the vacuum cleaner from the second position to a third desired position, so as to store the second movement of the vacuum cleaner in the memorizing means 20; and
(3^{rd}) moving the vacuum cleaner from the third position to a final desired position, so as to store the third movement of the vacuum cleaner in the memorizing means 20.

There are three sequences of movement of the vacuum cleaner stored in the memorizing means 20. Therefore, when the operation system 30 is switched to the play mode while the vacuum cleaner is re-positioned to its initial position, the vacuum cleaner will be driven to reproduce the three sequences of movements of the vacuum correspondingly. It is worth to mention that when the vacuum cleaner is moved from one position to another position, the wheel of the vacuum cleaner will drive the output shaft 11 to rotate so as to input the mechanical movement of the output shaft 11.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

1. A learn-and-play programming method for controlling a mechanical movement of an output shaft of a motorized toy and a domestic appliance, comprising the steps of:
(a) learning said mechanical movement of said output shaft by:
(a.1) inputting a movement data into an operation system corresponding to said mechanical movement of said output shaft; and
(a.2) storing said movement data of said output shaft in a memorizing means; and
(b) reproducing said mechanical movement of said output shaft corresponding to said movement data in said memorizing means.

2. The learn-and-play programming method, as recited in claim 1, in step (a.1), wherein said mechanical movement of said output shaft is input through a computer system by manually inputting said output shaft from an initial position to a final position.

3. The learn-and-play programming method, as recited in claim 2, in step (a. 1), wherein said movement data must be input into said operation system and stored in said memorizing means before inputting another movement data of said output shaft.

4. The learn-and-play programming method, as recited in claim 3, further comprising a step of clearing said movement data in said memorizing means in order to store a new set of said movement data from said output shaft in said memorizing means.

5. The learn-and-play programming method, as recited in claim 2, wherein, in step (2), said operation system is activated through said computer system to reproduce said mechanical movement of said output shaft corresponding to said movement data in said memorizing means.

6. The learn-and-play programming method, as recited in claim 4, wherein, in step (2), said operation system is activated through said computer system to reproduce said mechanical movement of said output shaft corresponding to said movement data in said memorizing means.

7. The learn-and-play programming method, as recited in claim 3, wherein a position of said output shaft in an analog form is converted into said movement data in a digital form to store in said memorizing means.

8. The learn-and-play programming method, as recited in claim 6, wherein said position of said output shaft in an analog form is converted into said movement data in a digital form to store in said memorizing means.

9. The learn-and-play programming method, as recited in claim 1, wherein, in step (a), said mechanical movement is pre-input into said output shaft and said movement data is pre-stored in said memorizing means.

10. The learn-and-play programming method, as recited in claim 6, wherein, in step (b), said operation system is activated to reproduce said mechanical movement of said output shaft corresponding to said movement data pre-stored in said memorizing means.

11. The learn-and-play programming method, as recited in claim 1, wherein, in step (a.1), said mechanical movement of said output shaft is input by manually rotating said output shaft from an initial position to a final position.

12. The learn-and-play programming method, as recited in claim 8, after the step (a.2), wherein said output shaft is rotated back to said initial position before said output shaft reproduces said corresponding mechanical movement thereof.

13. The learn-and-play programming method, as recited in claim 11, in step (a.1), wherein said movement data must be input into said operation system and stored in said memorizing means before inputting another movement data of said output shaft.

14. The learn-and-play programming method, as recited in claim 12, in step (a.1), wherein said movement data must be input into said operation system and stored in said memorizing means before inputting another movement data of said output shaft.

15. The learn-and-play programming method, as recited in claim 11, further comprising a step of clearing said movement data in said memorizing means in order to store a new set of said movement data from said output shaft in said memorizing means.

16. The learn-and-play programming method, as recited in claim 14, further comprising a step of clearing said movement data in said memorizing means in order to store a new set of said movement data from said output shaft in said memorizing means.

17. The learn-and-play programming method, as recited in claim 11, wherein said position of said output shaft in an analog form is converted into said movement data in a digital form to store in said memorizing means.

18. The learn-and-play programming method, as recited in claim 14, wherein said position of said output shaft in an analog form is converted into said movement data in a digital form to store in said memorizing means.

19. The learn-and-play programming method, as recited in claim 16, wherein said position of said output shaft in an analog form is converted into said movement data in a digital form to store in said memorizing means.

20. A learn-and-play control system for controlling a motorized toy and a domestic appliance which comprises an output shaft to provide a mechanical movement thereof, wherein said learn-and-play control system comprises:
means for memorizing said mechanical movement of said output shaft; and
an operation system which is communicatively connected with said memorizing means and is arranged to be operated between a learn mode and a play mode, wherein at said learn mode, said memorizing means is activated for memorizing said mechanical movement of said output shaft, and at said play mode, said operation system is activated for driving said output shaft to reproduce said mechanical movement thereof.

21. The learn-and-play control system, as recited in claim 1, wherein said operation system comprises a signal converter which is an analog to digital converter adapted for converting an analog signal of said mechanical movement from said output shaft to a digital signal, wherein said digital signal is stored in said memorizing means.

22. The learn-and-play control system, as recited in claim 1, wherein said operation system comprises a keyboard input interface which is an input device for mode selection to select said operation system between said learn mode and play mode.

23. The learn-and-play control system, as recited in claim 2, wherein said operation system comprises a keyboard input interface which is an input device for mode selection to select said operation system between said learn mode and play mode.
